(19) United States
(12) Patent Application Publication
(10) Pub. No.: US 2002/0080025 A1
(43) Pub. Date: Jun. 27, 2002

(54) Alarm monitoring systems and associated methods

(76) Inventor: Eric Beattie, Fife (GB)

Correspondence Address: FINNEGAN, HENDERSON, FARABOW,, GARRETT & DUNNER, L.L.P., 1300 I Street, N.W., Washington, DC, 20005, US

(21) Appl. No.: 09/985,049

(22) Filed: Nov. 1, 2001

(30) Foreign Application Priority Data
Nov. 1, 2000 (GB) 0026777.3
Nov. 1, 2000 (GB) 0026802.9
Nov. 1, 2000 (GB) 0026775.7
Nov. 1, 2000 (GB) 0026778.1

(51) Int. Cl. G08B 29/00

(52) U.S. Cl. 340/506; 340/540

(57) ABSTRACT

Systems and methods are provided for handling and monitoring alarm calls from subscribers. Consistent with embodiments of the invention, an alarm monitor system is provided at a subscriber location (such as house). The system includes a telephone receiver unit and line, and an alarm handset unit is connected to telephone line such that when alarm handset unit is pressed, an alarm call is made to a call center. The call center may includes operators who have access to a database of subscriber information. When an alarm call is received at the call center, a compiler outputs the subscriber information from database, and a return telephone call to the subscriber is made automatically by a transmit unit. The transmit unit may also passes on the alarm call and subscriber information to an operator and/or simultaneously add the operator into the return telephone call made to the subscriber.

### BACKGROUND OF THE INVENTION

I. Field of the Invention

The present invention generally relates to alarm systems and related methods for operating such systems. More specifically, the present invention relates to alarm monitoring systems and methods of operating such systems that can be used in various environments, including domestic residences, office buildings, industrial and commercial buildings, schools, hospitals, factories and other types of settings.

II. Background and Material Information

In response to concerns with safety and security, a wide variety of alarm systems have been developed and made available to the public. For example, home security systems are available to produce an alarm when an intruder, such as a burglar, has entered into or is in the vicinity of a domestic residence. In conventional home security systems, the presence of an intruder may be sensed by a motion or heat sensor. Other types of conventional security systems, such as those for office buildings and other types settings, also include similar sensors for detecting intruders or unauthorized entry.

When triggered, conventional security systems typically will produce an alarm signal to deter the intruder. These systems may also send a signal to a private security firm or company to trigger a call to the police to investigate the alarm condition at the residence or building where the intruder is detected. The police can then send an officer to investigate the alarm and, in certain cases, apprehend an intruder before there is an lost of property or damage.

Conventional alarm systems also exist that permit a person to contact a private call center under various emergency conditions requiring intervention by a police department, a fire department and/or an ambulance crew. Such systems may enable a person to contact a call center by dialing with a telephone and/or may include a panic button or remote device worn by the person to automatically activate a telephone call to the call center.

### SUMMARY OF THE INVENTION

Embodiments consistent with the present invention provide alarm monitoring systems and methods for operating such systems.

Alarm monitoring systems, consistent with embodiments of the invention, include an alarm handset unit provided at a domestic residence or building of a subscriber for initiating an alarm call under an emergency condition, and a call center for receiving the alarm calls from the subscriber and sending a return call to determine the nature of the emergency condition. The call center may be staffed with one or more operators, and include a database or databank of subscriber information.

Alarm monitoring systems of the present invention may be implemented to warn of any difficulty or danger which occurs at a subscriber's location, such as a break-in to the premises, a fire, a medical emergency, an assault on a person, any temporary or prolonged incapacity, and/or any situation in which the subscriber wishes to summon help or assistance. Alarm monitoring systems of the present invention may include or be integrated with security systems that include sensors for detecting intruders or alarm detection systems that are capable of detecting fires or other emergency conditions.

In accordance with embodiments of the invention, a method is also provided of operating an alarm monitoring system. The method comprises: sending an alarm call to a call center using an alarm handset unit; receiving the alarm call at the call center; and sending a return call from the call center to a subscriber location from which the alarm call originated. The subscribed location may be a domestic residence, an office building or any other type of location associated with the subscriber.

Optionally, the call center sends the return telephone call to the subscriber automatically, and/or the call center outputs subscriber information from a databank in response to the alarm call. Additionally or alternatively, an operator at the call center may be patched into the return telephone call made to the subscriber.

In accordance with an embodiment of the invention, when the return call is answered, the operator asks for a security number or code from the subscriber. Optionally, when the return call is answered, the operator asks for a security number or code, and if none is given or an incorrect number or code is given, then an emergency call is generated. Further, if the return call is not answered within a pre-determined period, then an emergency call may be generated.

According to additional embodiments of the present invention, a method is provided for operating an alarm monitoring system. The method comprises: sending an alarm call to a call center with an alarm handset provided at a domestic residence; and after sending the alarm call, disengaging the alarm handset from a telephone line of the domestic residence to await a return call from the call center.

Optionally, if there is no return call from the call center within a predetermined period, the alarm handset may make another alarm call.

According to further embodiments of the present invention, there is provided a method for operating an alarm monitoring system. The method comprises: monitoring, at a call center, for the receipt of one or more alarm calls; upon receipt of an alarm call, sending a return telephone call; and determining whether an alarm situation exists and/or what assistance is required.

Optionally, the call center may access and use stored information on a subscriber originating the alarm call. Further, if the return call is not answered, the call center may send an emergency call. Additionally or optionally, if the return call is answered with an incorrect response or is answered but with no response, the call center may send an emergency call.

Additional embodiments of the present invention provide systems and methods for registering a person to use the services of the call center.

Embodiments of the invention also provide methods of administering, managing, and processing subscriber information, all as defined by the embodiments of the present invention as described herein.

### BRIEF DESCRIPTION OF THE DRAWINGS

In order that the embodiments of the invention may more readily be understood, a description is now given, by way of example only, with reference to the accompanying drawings, in which:

FIG. 1 is an exemplary block diagram an alarm monitoring system, consistent with embodiments of the present invention;

FIG. 2 is an exemplary flow diagram of a method for operating the alarm monitoring system of FIG. 1; consistent with embodiments of the present invention;

FIGS. 3A and 3B illustrate exemplary alarm handset units, consistent with embodiments of the present invention;

FIG. 4 illustrates an exemplary screen display of subscriber information, consistent with embodiments of the present invention;

FIG. 5 is an exemplary block diagrams of a call center, consistent with embodiments of the present invention;

FIGS. 6A, 6B and 6C are exemplary flow diagrams of a method for operating the call center of FIG. 5; and

FIG. 7 illustrates an exemplary block diagram for implementing an alarm handset, consistent with embodiments of the present invention.

### DETAILED DESCRIPTION

Embodiments consistent with the present invention provide alarm monitoring systems and associated methods that may be implemented to warn of any difficulty or danger which occurs at a subscriber's location. Such emergency conditions may include a break-in to the premises, a fire, a medical emergency, an assault on a person, any temporary or prolonged incapacity, and/or any situation in which the subscriber wishes to summon help or assistance. While embodiments of the invention are primarily described in relation to use in a domestic house or residence, embodiments of the invention are equally applicable to use in other applications, for example, in hospitals, schools, factories, offices or any industrial or commercial multi-occupancy buildings.

Alarm monitoring systems consistent with embodiments of the invention include an alarm handset unit provided at a subscriber's location (such as a domestic residence) for initiating an alarm call under an emergency condition. A remote call center is also provided for receiving the alarm calls and sending a return call to the subscriber to determine the nature of the emergency condition. The call center may be staffed with one or more operators, and include a database or databank of subscriber information. Optionally, alarm monitoring systems of the present invention may include or be integrated with security systems that include sensors for detecting intruders or alarm detection systems that are capable of detecting fires or other emergency conditions.

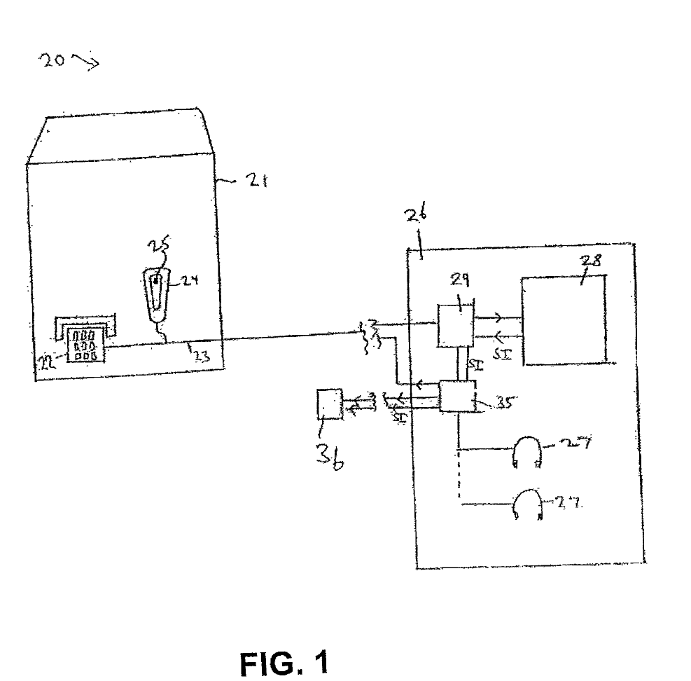

FIG. 1 is an exemplary block diagram of an alarm monitoring system 20, consistent with embodiments of the present invention. As illustrated in FIG. 1, a telephone receiver unit 22 and telephone line 23 are provided at a subscriber location 21. The subscriber location 21 may be a domestic residence, an office building or any other type of setting. At the subscriber location 21, an alarm handset unit 24 is also provided. The alarm handset unit 24 may be permanently connected, via a two-way connector, into the telephone line 23 such that, when alarm button 25 is pressed, an alarm call is made via the telephone line to a call center 26. In accordance with embodiments of the invention, the alarm handset unit 24 may also be implemented as a cordless device, whereby a base unit is connected to the telephone line 23 and communicates wirelessly with the alarm handset unit.

The call center 26 which is permanently manned or staffed with one or more operators 27. Each of the operators 27 have access to a database 28 that stores subscriber information for each subscriber. To access and view subscriber information, each of the operators 27 may be stationed at a computer workstation or terminal (not illustrated) that is configured to receive subscribed information from database 28. Although FIG. 1 illustrates the database 28 as being a central database for the call center 26, all of the subscriber information stored in database 28 may be replicated or distributed to local storage or memory devices for each operator 27 (such as in the local memory of computer workstation for an operator).

The alarm call from the subscriber location 21 may be sent according to various predetermined formats. For example, an alarm call to call center 26 may comprise a signal in the V.23 modem format. Consistent with embodiments of the invention, each alarm call message includes appropriate data content to uniquely identify the subscriber, such as a serial number identifying the actual alarm handset 24 of the subscriber.

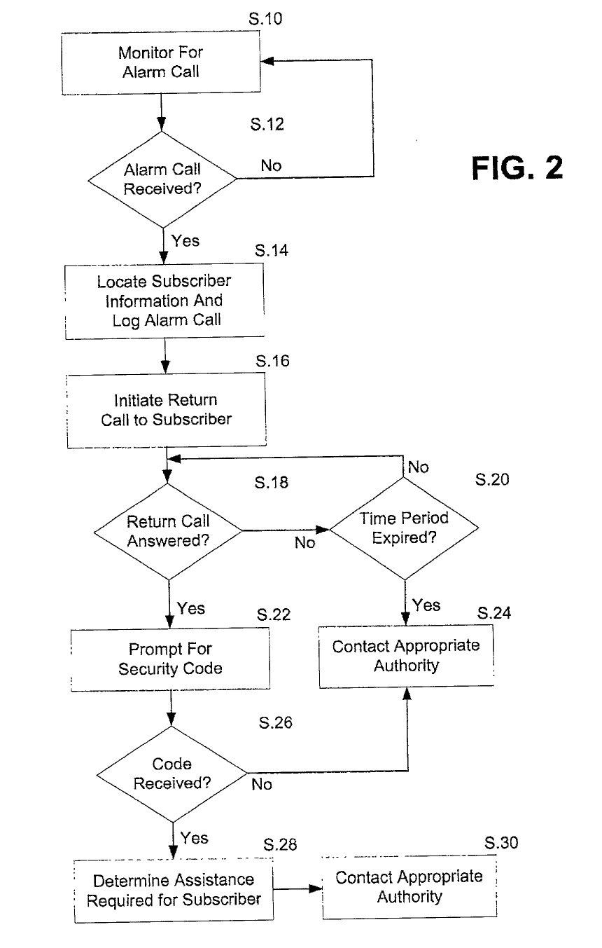

FIG. 2 is an exemplary flow diagram of a method for operating the alarm monitoring system 20 of FIG. 1. As illustrated in FIG. 2, call center 26 monitors for alarm call(s) from subscribers (step S.10). When an alarm call is received at the call center 26 (step S.12; Yes), the alarm call is analyzed by compiler 29 to determine the subscriber identity. As indicated above, the alarm call message may include information to uniquely identify the subscriber (such as a serial number of the alarm handset 24). With the subscriber identity information, the complier 29 requests and accesses the subscriber information (SI) stored in the database 28 (step S.14). In addition, the subscriber information is provided as output from the compiler 29 to a transmit unit 35 and the alarm call is logged (step S.14).

As further described below, the subscriber information accessed from the database 28 may include various information concerning the subscriber, such as a telephone number of a subscriber's home or domestic residence. Based on the subscriber information, the transfer unit 35 automatically initiates a return telephone call to the subscriber, so that the process is started immediately (step S.16).

Once the alarm call is logged as being received at the call station 26 (step S.14), the connection with the alarm handset unit 24 is preferably broken (for example, by the call center 26 sending a signal or tone to handset unit 24 effect this), so that the call center 26 can make the return telephone call to the subscriber. When an alarm call is logged, the transmit unit 35 may also passes the alarm call and subscriber information (SI) to one of the operators 27 that is free to handle the alarm call. Additionally, the transmit unit 35 may simultaneously add the operator 27 into the return telephone call made to the subscriber.

Consistent with an embodiment of the invention, if the alarm handset unit 24 determines, within a predetermined period, that a return call has not been made to the subscriber, the unit 24 may send a repeat call to the call center 26. Additionally or optionally, unit 24 may send a call direct to the police and/or emergency service, with an indication of what has already been sent and/or details of the subscriber.

When an alarm call is received by the call center 26 and forwarded to an operator 27, the operator may automatically be provided with the subscriber information accessed from the database 28. By way of example, the subscriber information (SI) may include one or more of the following items of information: address of the subscriber's location or house 21; location of alarm handset unit 24 (as there may be more than one handset 24 in a house) within the subscriber's home; the name(s), age(s) and medical condition or medical information of the occupant(s) of home 21 as registered with the call center; the telephone number of the subscriber's home 21; the telephone number of the nearest police station; the telephone number of any contact persons; the telephone number of the nearest ambulance call-out; the telephone number of the nearest fire station center call-out; a password, security number or code pre-agreed with the subscriber; and/or history of the subscriber's use of the service and of previous calls.

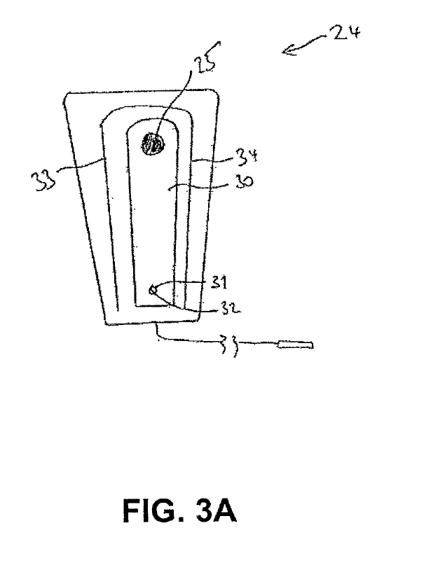

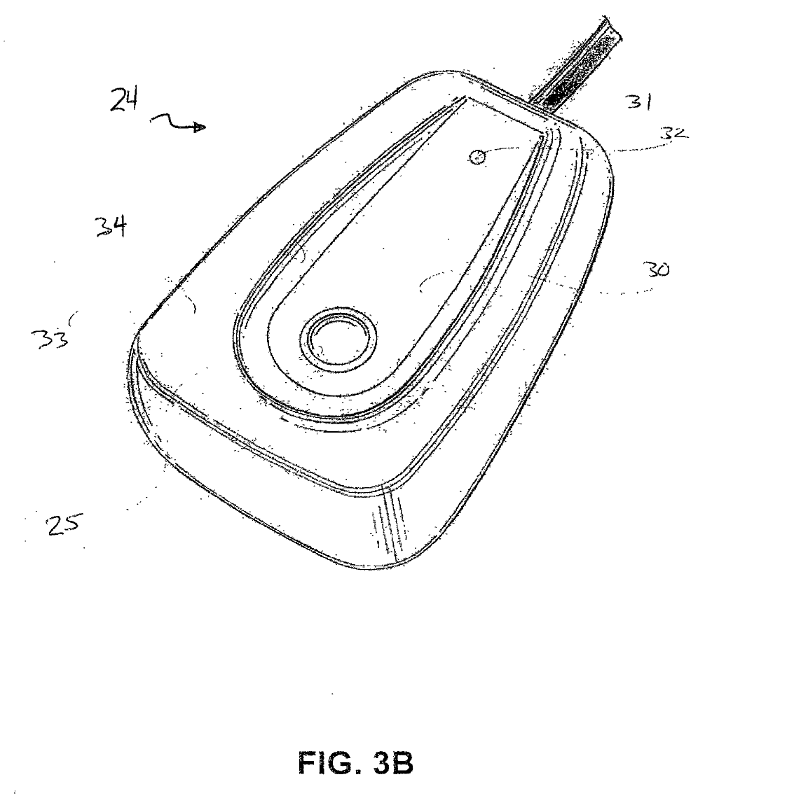

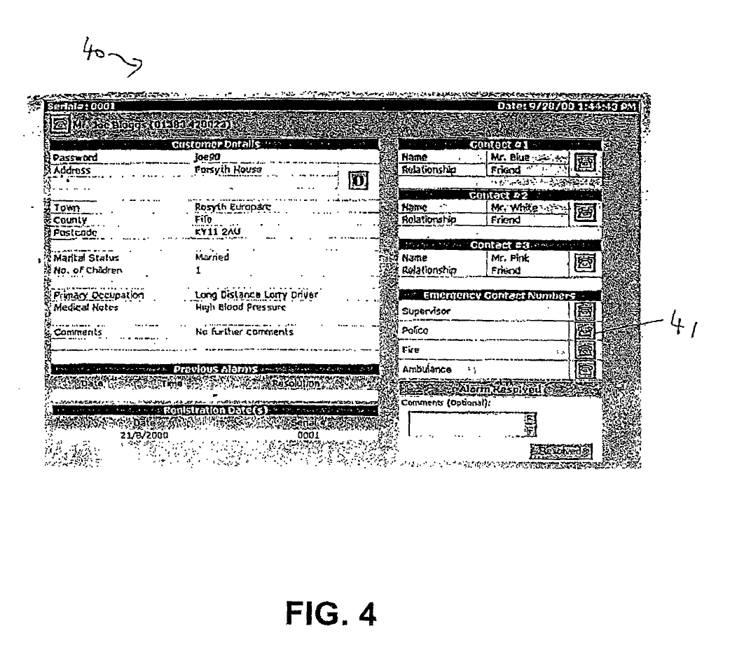

The subscriber information may be displayed at a computer workstation or terminal of the operator 27. Various display screen formats and arrangements may be provided for this purpose. An example of such a display 40 of subscriber information (SI) that can be provided on display screen 40 of an operator 27 is provided in FIG. 3.

If the return telephone call is answered (step S.18; Yes), then the operator 27 asks for the security number or code corresponding to that which is provided in the subscriber information stored in database 28 (step S.22). If this is correctly given (step S.26; Yes), then the operator asks if any further assistance is required (step S.28). Thereafter, the operator 27 may contact the appropriate authority (such as the local police, fire department and/or ambulance service) to make sure that the subscriber gets the appropriate assistance (step S.30).

If the security number or code given differs, or if no security number or code is given (step S.26; No), then the operator immediately activates a button 41 on display screen 40 to make transmit unit 35 send an emergency telephone call to telephone the nearest, appropriate authority 36 (step S.24). By way of example, a local police station may be contacted to investigate the alarm call. The operator 27 may also fax or electronically send the subscriber information on the display to the authority 36 either in its entirety or in part.

As illustrated in FIG. 2 (step S.18; No; step S.20; Yes), if the return telephone call is not answered within a predetermined time period (e.g., 30 seconds), the operator 27 activates button 41 to contact the appropriate authority 36 to investigate the alarm call (step S.24). For example, the operator 27 may telephone the nearest police station, an ambulance call-out center and/or a fire station call-out center. When contacting the appropriate authority, the operator 27 may provide all of the subscriber information that was accessed from the database 28. The information as sent (for example, by fax or electronically by e-mail) may also indicate that a return telephone call was made to the subscriber but that the call has not been answered.

When an authority 36 is contacted, the transmit unit 36 may connect the operator 27 into the emergency call being made to the authority (such as the police). Thus, the operator 27 can provide the police with any further information required and generally handle the matter (for example, discussing with the police whether to alert other emergency services and/or take other action). In this way, as soon as an alarm call is received at the alarm call monitor center, an immediate appropriate response is made. Clearly, the emergency call can be made to other emergency services additionally and/or alternatively to the police as appropriate.

FIGS. 3A and 3B illustrate exemplary alarm handset units, consistent with embodiments of the invention. The exemplary embodiments of FIGS. 3A and 3B may be used in connection with any of the exemplary systems or methods disclosed herein. As illustrated in FIGS. 3A and 3B show the front face of an alarm handset unit 24, which has alarm button 25 designated by a circular area and forming a slightly raised domed portion as compared to the flat surrounding region 30. When slight pressure is applied to button 25 (e.g., by a human finger), there is a responsive physical depression and audible click, thereby giving a positive feedback that switching has been achieved.

As further illustrated in FIGS. 3A and 3B, handset 24 has a transparent circular portion 31 through which there can be seen a light-emitting diode 32 which is illuminated when handset 24 is plugged into the telephone system. Region 30 may be impregnated with fluorescent material so that the front face of handset 24 can be seen in the dark.

Alarm handset unit 24 may also include two lateral walls 33 and 34 on either side of the long side edges of region 30, being bridged by a third wall 35, the three walls forming a U-shape with button 25 located at its apex, the height of walls 33 and 34 increasing towards button 25. In this way, the front face of handset unit 24 is shaped so that a person is able to readily and quickly locate the button area 25 by touch alone (e.g., in the dark or in a smoky atmosphere) having little or no familiarity with the design of the handset.

Consistent with embodiments of the invention, the alarm handset unit 24 is incorporated in a telephone answering machine. Further, consistent with embodiments of the invention, the handset 24 may have a wire-less link (e.g., by infra-red, ultra-sonic, radio-frequency or optical signals) to a base unit connected to the telephone system, for example, allowing the handset to be worn by the subscriber or to be carried around the subscriber's location or house 21. Information on such a location can be included in the subscriber information (SI) stored in the database 28.

Consistent with embodiments of the invention, the call center 26 may incorporate a speech processor unit so that a standard speech message can be given should the call be answered by someone at the subscriber's location or house 21, and also that any response given can be analyzed (for example, automatically) to establish whether the correct pre-agreed, password, security number or code is provided. Therefore, with such a modification to the call center, increased automated operation may be achieved.

Various registration procedures for setting up a handset 24 with the alarm monitor system 26 of FIG. 1 may be provided. For example, to start a registration procedure, the subscriber may telephone the call center 26 using the telephone 22 at house 21. An operator 27 may then ask the subscriber a series of questions and input the appropriate subscriber information into database 28. The operator 27 may also instruct the compiler 29 to enter the “program handset” mode and ask the subscriber to connect handset 24 to the telephone line and activate the alarm on handset 24. The handset 24 may then send a “ready to program” message to the call center 26 which responds by sending the configuration information to the handset 24. Once programmed, handset 24 sends a “confirm programmed” message to call center 26. The operator 27 then advises the subscriber that programming has been completed and asks the subscriber to conduct a test activation to ensure that the system is operating correctly.

At predetermined intervals (e.g., every month), handset unit 24 may send a message to call center 26 to check if any changes are to be made to the procedure for alarm calls (e.g., the telephone number of the call center, or the subscriber information). This also acts as a check to monitor which handsets are no longer in use.

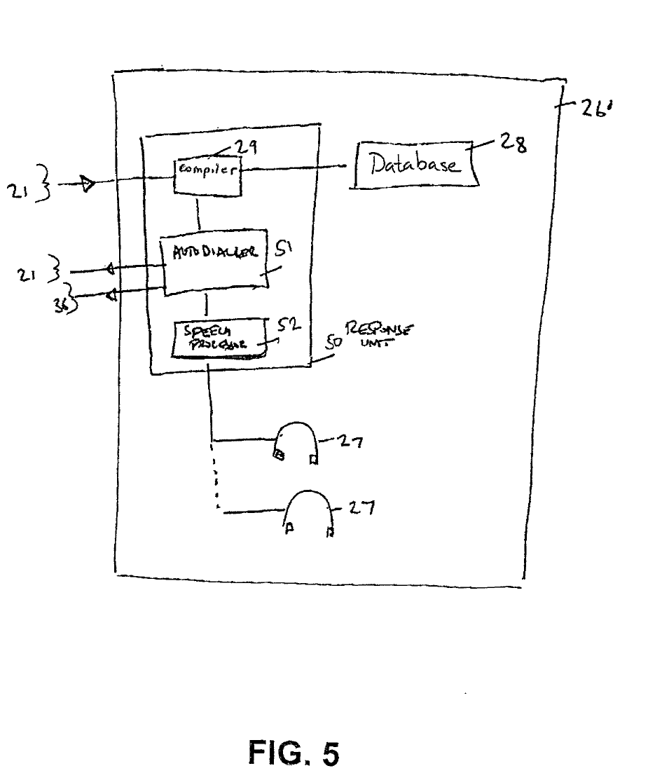

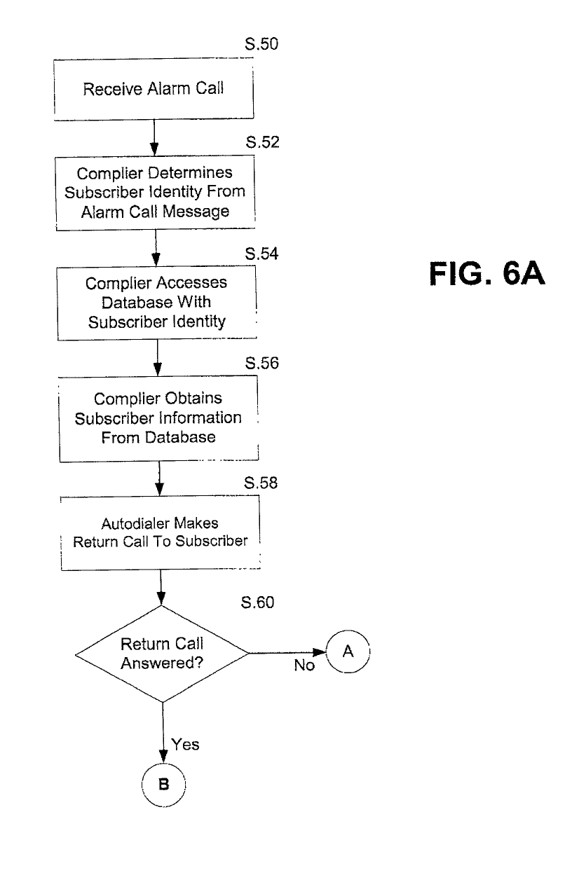

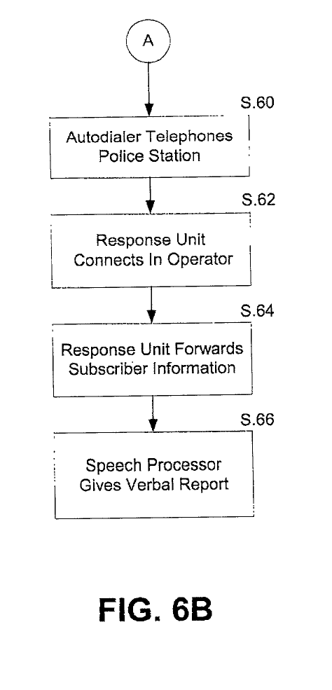

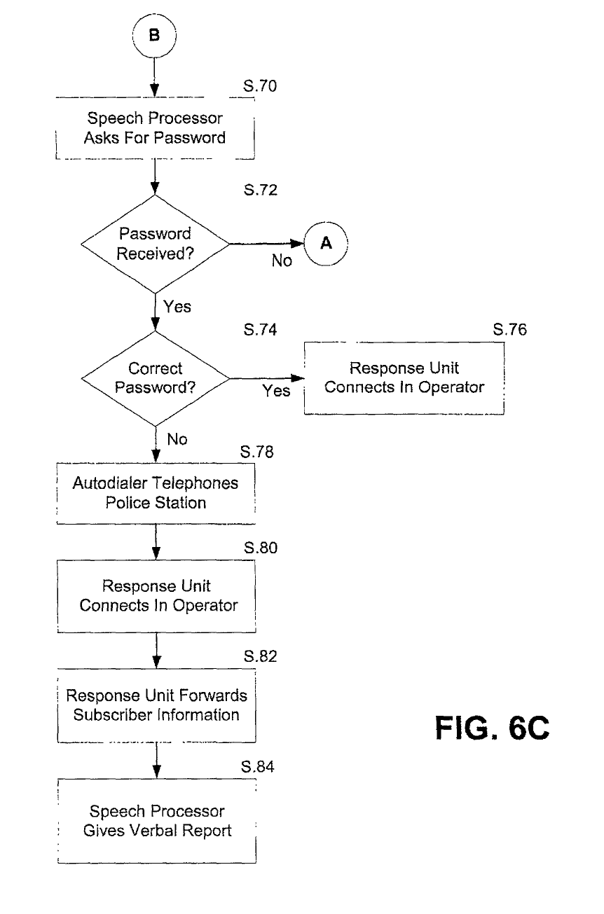

Consistent with embodiments of the invention, FIG. 5 illustrates an exemplary call center 26′ that includes a response unit 50 incorporating autodialer 51 and speech processor 52 which sends out an speech message and also analyzes a speech message that it receives and acts accordingly. FIGS. 6A-6C are exemplary flow diagrams which set out the sequence of operation of call center 26′.

As illustrated in FIG. 6A, when an alarm call is received at the call center 26′ (step S.50), the alarm call is analyzed by compiler 29 to determine the subscriber identity from the alarm call message (step S.52). As indicated above, the alarm call message may include information to uniquely identify the subscriber (such as a serial number of the alarm handset 24). With the subscriber identity information, the complier 29 requests and accesses the subscriber information (SI) stored in the database 28 (step S.54). After the subscriber information (including the subscriber's telephone number) is obtained by the compiler 29 (step S.56), the subscriber information is used by the autodialer 51 to make the return call to the subscriber (step S.58).

When an alarm call is received by the call center 26′, the alarm call and subscriber information may be forwarded to an operator 27. As indicated above, the subscriber information may be displayed at a computer workstation or terminal of the operator 27. Various display screen formats and arrangements may be provided for this purpose. Once again, an example of such a display 40 of subscriber information (SI) that can be provided on display screen 40 of an operator 27 is provided in FIG. 3.

If the return telephone call is answered (step S.60; Yes), then the speech processor 52 is enabled to prompt for the password or security code (step S.70). As illustrated in FIG. 6C, if the password is correctly given (step S.74; Yes), then the response unit 50 may automatically connect in an operator 27 and the operator may ask if any assistance is required (step S.76). Thereafter, the operator 27 may contact the appropriate authority (such as the local police, fire department and/or ambulance service) to make sure that the subscriber gets the appropriate assistance.

If the password differs (step S.74; No), then the autodialer 51 immediately dials an emergency telephone call to telephone the nearest, appropriate authority 36, such as the police (step S.78). The response unit 50 may also connect in an operator 27 (step S.80) on the emergency call. Thereafter, the operator 27 may forward (by fax or electronically) the subscriber information to the police station (step S.82). The speech processor 52 may also be activated to give a verbal report to the police and/or the operator (step S.84).

If the return call is not answered (step S.60; No) or if no password is received within a predetermined time period (step S.72; No), then the autodialer 51 may be activated to initiate a call to the appropriate authority 36. In particular, as illustrated in FIG. 6B, the autodialer 51 may telephone the local police station (step S.60). Simultaneously, the response unit 50 may also connect in an operator 27 to the call (step S.62). The response unit 50 or the operator 27 may then provide or forward the subscriber information to the police station (step S.64). The speech processor 52 may also be activated to give a verbal report to the police and/or the operator of the attempted return call to the subscriber and/or any call activity (step S.66).

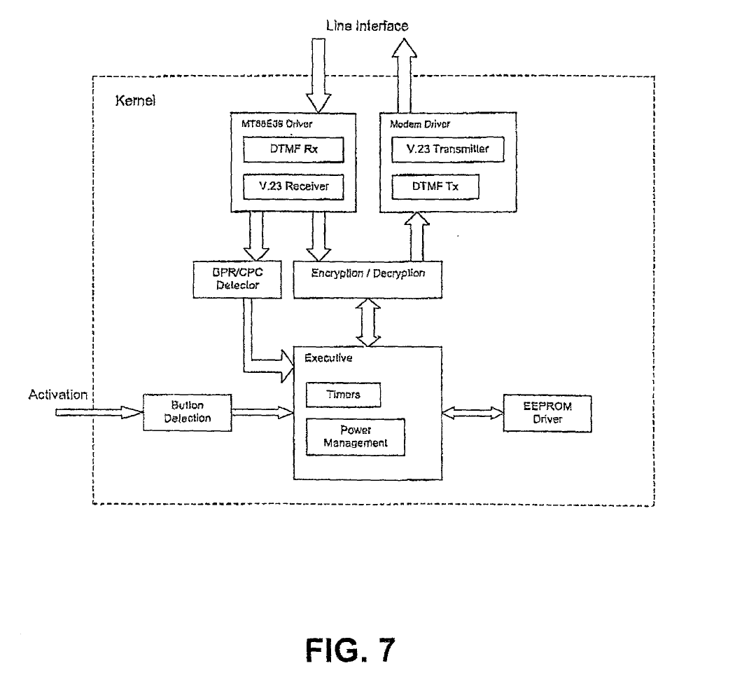

FIG. 7 illustrates an exemplary embodiment for implementing part of the alarm handset unit 24. The alarm handset unit 24 may be implemented with two distinct versions, each representing one method of communication currently supported by the call center. The first version uses ITU-T V.23 signaling to transfer data between the alarm handset unit and the call center. The second version facilitates DTMF signaling to communicate. V.23 signaling provides transfer rates to allow secure encryption of data. The hardware design is not affected by the signaling method.

At the subscriber's location, the alarm handset unit is installed onto a telephone line. As indicated above, initial registration is required to allow the call center to track the user in the subscriber database 28. Typically, this will require a subscriber or client to make a voice call to the call center in order to extract subscriber information, program the handset unit with serial number and phone number (if off-hook data and voice is possible simultaneously) and allow a brief subscriber confidence test of the handset unit.

The subscriber information for each subscriber is stored in the call center's database and may be indexed by serial number (presented by the handset unit). The first call initiated by the subscriber or client (i.e., by pressing the button on the handset) may be charged to the subscriber as a test call. Thereafter, a button activation press forces the line to be siezed, a preprogrammed call center number is called and the line dropped. A call center representative responds within a given time by call back to the subscriber's location or site. A subscriber password or code is required to authenticate the legitimacy of the button activation. If there is no answer within a predetermined time or number of rings, or if the receipt is of an incorrect password, the appropriate public service or contact can be phoned, as described above.

Consistent with embodiments of the invention, the alarm handset unit 24 may be implemented with a Hitachi H83664 16-bit CPU, an associated EEPROM which may store serial number, phone numbers, and code updates a MITEL MT88E39 DTMF/V.23 decoder, a BPR/CPC detector, a ring and speech detector, a hardware watchdog and/or a D/A resistance ladder for modulation encoding.

The handset communication system uses hardware and software to allow ITU-T V.23 and DTMF signalling. A Mitel MT88E39 CLI decoder presents the receive data path via the decryption module to the kernel. The transmit data path may be realized by a software implementation of a dual sine wave sample generator for V.23 signals and an implementation of a realtime Z-transform of dual sine wave sample generation for DTMF signals. The DTMF generator can be used exclusively for dialling in the V.23 version of the handset unit and is used for both dialling and signalling in the DTMF version. In both cases, the generated samples can be output via an 8-bit port onto the R2R resistance ladder and smoothed by filters before being applied to line.

In accordance with an embodiment of the invention, Branch Phone Resets are detected via hardware and debounced in software to allow call cleardown when a telephone is taken off-hook on a shared line. Likewise, a Call Progress Cleardown signal may be received from the network and is handled in similar fashion.

Encryption and decryption of data via a public key algorithm such as RSA or 40-bit DES/3DES may be utilized to prevent malicious hacking of the call center.

Non-volatile storage for serial number, phone numbers, keys, historical data, etc. may be implemented with Philips I2C 2-wire bidirectional bus on which a 32 Kbit EEPROM resides. A thermo device may also be placed on this bus for a heat/smoke detector application.

Consistent with embodiments of the invention, the CPU of the handset may remain in a low-current powered-down idle state until activation via the activation switch. During this state, the real-time clock and calendar functions and various housekeeping duties are performed. When an interrupt caused by activation occurs, the CPU is forced into its normal high-speed execution state running from the onboard 10/16 MHz oscillator.

The datalink and presentation layers may be implemented to provide a message based link between call center and alarm handset unit.

The following table provides definitions for the acronyms used herein:

| Acronym | Definition |
|---|---|
| PSTN | Public Switched Telephone Network |
| CLI | Caller Line Identity |
| EEPROM | Electrically Erasable and Programmable Read Only Memory |
| CPU | Central Processing Unit |
| DTMF | Dual Tone Multiple Frequency |
| D/A | Digital to analogue |
| BPR | Branch Phone Reset |
| CPC | Call Progress Cleardown |
| ITU-T | International Telecommunication Union - Telecommunication |
| | Standardization Sector |

The invention is not limited to the particulars of the embodiments disclosed herein. Other embodiments of the invention will be apparent to those skilled in the art from consideration of the specification and practice of the systems and methods disclosed herein. Further, individual features of each of the disclosed embodiments may be combined or added to the features of other embodiments of the present invention. In addition, the steps of the disclosed methods herein may be combined or modified without departing from the spirit of the invention claimed herein. Accordingly, it is intended that the specification and examples be considered as exemplary only, with a true scope and spirit of the invention being indicated by the following claims.

The present application claims priority to GB Patent Application No. 0026775.7 (filed Nov. 1, 2000), GB Patent Application No. 0026777.3 (filed Nov. 1, 2000) GB Patent Application No. 0026778.1 (filed Nov. 1, 2000), and GB Patent Application No. 0026802.9 (filed Nov. 1, 2000), the disclosures of which are expressly incorporated herein by reference to their entireties.

What is claimed is:

1. A method for operating an alarm monitoring system, the method comprising:
sending an alarm call to a call center using an alarm handset unit located at subscriber location,
receiving the alarm call at the call center,
sending, from the call center, a return telephone call to the subscriber location from which the alarm call originated.

2. A method according to claim 1 wherein the call center sends the return telephone call to the subscriber location automatically.

3. A method according to claim 1 further comprising locating, at the call center, subscriber information (SI) from a database in response to the alarm call.

4. A method according to claim 1 wherein an operator is patched into the telephone call made to the subscriber.

5. A method according to claim 1 wherein, when the return call is answered, the operator asks for a security number or code.

6. A method according to claim 1 wherein, when the return call is answered the operator asks for a security number or code, and if none is given or an incorrect number or code is given, then an emergency call is generated.

7. A method according to claim 1 wherein, if the return call is not answered within a pre-determined period, an emergency call is generated.

8. A method for operating an alarm monitoring system, the method comprising:
sending an alarm call to a call center using an alarm handset unit located at a domestic residence of a subscriber; and
disengaging the alarm handset unit from a telephone line to await a return call from the call center.

9. A method according to claim 8 wherein, if there is no return call from the call center within a predetermined period, then the handset unit makes another alarm call.

10. A method for operating an alarm monitoring system, the method comprising:
monitoring, at a call center, for receipt of one or more alarm calls; and
upon receipt of an alarm call, automatically sending a return telephone call from the call center to determine whether an alarm situation exists and/or what assistance is required.

11. A method according to claim 10 wherein the call center uses stored information on the subscriber originating the alarm call to send the return telephone call.

12. A method according to claim 10 wherein, if the return call is not answered, the call center sends an emergency call.

13. A method according to claim 10 wherein, if the return call is answered within an incorrect response or is answered but with no response, the call center sends an emergency call.

14. A method for administering an alarm monitoring system, the method comprising:
receiving, at a call center, an alarm call from a subscriber location;
reacting to an alarm call by sending a return call to the subscriber location to determine whether an alarm situation exists and/or what assistance is required.

15. A method according to claim 14 wherein the call center uses stored information on the subscriber originating the alarm call.

16. A method according to claim 14 wherein if the return call is not answered, the call center sends an emergency call.

17. A method according to claim 14 wherein, if the return call is answered with an incorrect response or is answered but with no response, the call center sends an emergency call.

18. A method for managing an alarm monitoring system, the method comprising:
monitoring, at a call center, for receipt of one or more alarm calls; and
upon receipt of an alarm call, reacting to the alarm call by assigning the alarm call to an operator and sending a return call to the subscriber to determine whether an alarm situation exists and/or what assistance is required.

19. A method according to claim 18 wherein the call center uses stored information on the subscriber originating the alarm call.

20. A method according to claim 18 wherein, if the return call is not answered, the call center sends an emergency call to an appropriate authority.

21. A method according to claim 18 wherein, if the return call is answered with an incorrect response or is answered but with no response, the call center sends an emergency call to an appropriate authority.

22. An alarm monitoring system, comprising:
an alarm handset unit connected to telephone line at a subscriber's location, the alarm handset unit including a button for automatically activating an alarm call; and
at least one call center for receiving alarm call from the subscriber location, the call center including a database for storing subscriber information associated with the subscriber location and a compiler adapted to determine a subscriber identity from the alarm call and access the subscriber information from the database based on the subscriber identity.

23. An alarm monitoring system of claim 22, further comprising a transmit unit, located at the call center, that automatically initiates a return telephone call to the subscriber location based on the subscriber information located by the compile.

24. An alarm monitoring system of claim 23, wherein the transmit unit automatically adds an operator at the call center into the return telephone call made to the subscriber location.
